(19) United States
(12) Patent Application Publication
(10) Pub. No.: US 2026/0265868 A1
(43) Pub. Date: Sep. 10, 2026

(54) METHOD FOR RECOVERING RARE EARTH ELEMENTS FROM RARE EARTH PERMANENT MAGNETS BY USING DEEP EUTECTIC SOLVENT

(71) Applicant: Korea Institute Of Geoscience And Mineral Resources, Daejeon (KR)

(72) Inventors: Rina KIM, Busan (KR); Ho Sung YOON, Seoul (KP); Seo Jin HEO, Daejeon (KR); Chul Joo KIM, Daejeon (KR); Kyeong Woo CHUNG, Daejeon (KP)

(73) Assignee: Korea Institute Of Geoscience And Mineral Resources, Daejeon (KR)

(21) Appl. No.: 19/165,859

(22) PCT Filed: Oct. 24, 2023
(86) PCT No.: PCT/KR2023/016593

§ 371 Date: Sep. 16, 2025

(30) Foreign Application Priority Data
Mar. 17, 2023 (KR) 10-2023-0035243

(51) Int. Cl. C22B 59/00; C22B 1/02; C22B 1/248; C22B 7/00

(52) U.S. Cl. CPC C22B 59/00; C22B 1/02; C22B 1/248; C22B 7/007; C22B 7/008

(57) ABSTRACT

The present invention relates to a method for recovering rare earth elements from rare earth permanent magnets by using a eutectic solvent, wherein the recovery efficiency of rare earth elements is improved by selectively leaching rare earth elements from rare earth permanent magnets by using a eutectic solvent, and the process can be performed in an environmentally friendly manner by reducing the quantities of acid consumption and wastewater generation.

### TECHNICAL FIELD

The present disclosure relates to a method for recovering rare earth elements from rare earth permanent magnets. In particular, the present disclosure relates to a method for recovering rare earth elements from rare earth permanent magnets using a deep eutectic solvent.

### BACKGROUND ART

Rare earth elements are defined as a group of seventeen chemical elements in the periodic table, namely fifteen lanthanide elements together with yttrium (Y) and scandium (Sc), which are a type of rare metal and are essentially used in various industrial fields. Rare earth permanent magnets utilizing rare earth elements have been increasingly produced for electronic and information devices in response to the worldwide spread of computers, and recently, the demand has been continuously increasing, particularly in the fields of environment, automobiles, and bio-industries.

In particular, neodymium (Nd) and dysprosium (Dy) permanent magnets among rare earth permanent magnets are essentially used in hard disk drives, wind power generation, hybrid vehicles, and the defense industry. Although a continuous increase in demand for neodymium-iron-boron (Nd—Fe—B) magnets among rare earth permanent magnets is expected, in the case of Korea, most of the materials and raw materials are dependent on imports, and in particular, the supply of rare earth elements is unstable as well as the amount of available natural resources being insufficient.

In this regard, Korea is seeking strategies to secure a stable supply of rare earth elements. As one of the strategies, studies on recycling technologies of rare earth permanent magnets have been conducted, and in particular, various process developments for recycling neodymium-iron-boron (Nd—Fe—B) permanent magnets have been carried out due to the supply situation and importance of rare earth resources.

Conventional hydrometallurgical processes capable of recovering rare earths have been researched and developed. In a method of selectively dissolving rare earths, since the iron component exists as ferric oxide (Fe₂O₃), in order to suppress the dissolution of the iron component, weak acid leaching is carried out at an aqueous solution pH of 3 or higher where ferric oxide is not dissolved. However, in this process, the dissolution rate of rare earths is very low, resulting in a very long processing time. In addition, there are problems in that large amounts of chemicals and water are consumed, a large volume of wastewater is generated because the acidic aqueous solution is difficult to reuse after leaching, and most hydrometallurgical processes using acidic aqueous solutions have low selectivity, which makes them unsuitable for recovering metals from low-grade ores, tailings, or industrial wastes.

Accordingly, there is an urgent need to develop an efficient method for recovering rare earth elements that can selectively leach and separate rare earth elements.

### DISCLOSURE

### Technical Problem

In order to solve the aforementioned problems, a purpose of the present disclosure is to provide a method for recovering rare earth elements with improved efficiency by selectively leaching rare earth elements from rare earth permanent magnets.

In addition, another purpose of the present disclosure is to provide a method for recovering rare earth elements that reduces acid consumption and minimizes purification steps.

Furthermore, still another purpose of the present disclosure is to provide a method for recovering rare earth elements in an environmentally friendly manner by reducing the amount of wastewater generated.

The challenges that the present disclosure is intended to solve are not limited to those mentioned above, and other challenges not mentioned will be apparent to those skilled in the art from the following description.

### Technical Solution

In order to achieve the purpose, an aspect of the present disclosure provides a method for recovering rare earth elements from rare earth permanent magnets, comprising:
(a) crushing the rare earth permanent magnets;
(b) digesting the crushed material obtained in step (a) in an alkaline solution;
(c) subjecting the digested material obtained in step (b) to oxidative roasting; and
(d) leaching the oxidatively roasted material obtained in step (c) with a deep eutectic solvent.

In some exemplary embodiments, in step (a), the rare earth permanent magnets may be neodymium-iron-boron (Nd—Fe—B) based permanent magnets.

In some exemplary embodiments, in step (a), the rare earth permanent magnets may be waste permanent magnet scraps or permanent magnet sludges.

In some exemplary embodiments, in step (a), the rare earth permanent magnets may be crushed to have a particle size of 100 μm or less.

In some exemplary embodiments, in step (b), the alkaline solution may have a concentration of 40 to 60% (w/w).

In some exemplary embodiments, in step (b), the digesting may be carried out at a solid-to-liquid ratio of 5 to 20% (w/v).

In some exemplary embodiments, in step (b), the digesting may be carried out at 120 to 160° C. for 3 to 7 hours.

In some exemplary embodiments, the oxidative roasting in step (c) may be carried out at 400 to 500° C. for 2 to 5 hours.

In some exemplary embodiments, the deep eutectic solvent in step (d) may be a mixture of a hydrogen bond acceptor (HBA) and a hydrogen bond donor (HBD),
the hydrogen bond acceptor may be selected from the group consisting of guanidine hydrochloride, choline chloride, ethylene glycol, N-ethyl-2-hydroxy-N,N-dimethylethanaminium chloride, 2-(chlorocarbonyloxy)-N,N,N-trimethylethanaminium chloride, N-benzyl-2-hydroxy-N,N-dimethylethanaminium, 1-aminoguanidine hydrochloride, 1,3-diaminoguanidine hydrochloride, methanol, betaine hydrochloride, benzylcholine chloride, tetrabutylammonium chloride, glycerol, 1,2-propandiol, and 1,4-butanediol,
and the hydrogen bond donor may be selected from the group consisting of lactic acid, maleic acid, urea, acetamide, 1-methyl urea, 1,3-dimethyl urea, 1,1-dimethyl urea, thiourea, benzamide, glycerol, ethylene glycol, malonic acid, benzoic acid, adipic acid, oxalic acid, succinic acid, citric acid, malic acid, glycolic acid, proline, glucose, p-toluene sulfonic acid, tartaric acid, fructose, phenol, menthol, decanoic acid, ibuprofen, lidocaine, and sucrose.

In some exemplary embodiments, the deep eutectic solvent may be prepared by mixing guanidine hydrochloride and lactic acid at a molar ratio of 1:2 to 1:8.

In some exemplary embodiments, the preparation of the guanidine hydrochloride-lactic acid may be carried out at 60 to 80° C.

In some exemplary embodiments, the deep eutectic solvent may be prepared by mixing choline chloride and lactic acid at a molar ratio of 1:1 to 1:10.

In some exemplary embodiments, the preparation of the choline chloride-lactic acid may be carried out at 60 to 80° C.

In some exemplary embodiments, the deep eutectic solvent may be prepared by mixing ethylene glycol and maleic acid at a molar ratio of 1:1 to 6:1.

In some exemplary embodiments, the preparation of the ethylene glycol-maleic acid may be carried out at 50 to 70° C.

In some exemplary embodiments, the leaching in step (d) may be carried out by applying ultrasound at 60 to 80° C. for 4 to 6 hours.

In some exemplary embodiments, the method for recovering rare earth elements from rare earth permanent magnets may further comprise: (e) reacting a leachate obtained in step (d) with an acid.

### Advantageous Effects

According to an exemplary embodiment of the present disclosure, by selectively leaching rare earth elements from waste permanent magnets or wastes containing rare earth elements and iron compounds, the recovery efficiency can be improved.

In addition, according to an exemplary embodiment of the present disclosure, in the method for recovering rare earth elements, the consumption of acid can be reduced and the purification steps can be minimized.

Moreover, according to an exemplary embodiment of the present disclosure, in the method for recovering rare earth elements, the amount of wastewater generated can be decreased, thereby enabling the process to be performed in an environmentally friendly manner.

The effects of the present disclosure are not limited to the aforementioned effects and should be understood to include all effects that can be inferred from the configurations of the present disclosure described in the detailed description or the claims.

### DESCRIPTION OF DRAWINGS

FIG. 1 is a process flow diagram illustrating a method for recovering rare earth elements from rare earth permanent magnets according to the present disclosure.

### MODE FOR INVENTION

Hereinafter, exemplary embodiments of the present disclosure will be described in detail with reference to related drawings.

The advantages and features of the present disclosure, and methods of accomplishing those advantages and features, will become apparent upon reference to the exemplary embodiments described in detail with reference to the accompanying drawings.

However, the present disclosure is not limited by the exemplary embodiments disclosed herein, but will be embodied in many and various forms. Therefore, those exemplary embodiments are provided merely to make the present disclosure complete and to give a complete picture of the scope of the present disclosure to one of ordinary skill in the art to which the present disclosure belongs, and the present disclosure shall be defined by the scope of the claims.

Further, hereinafter, in describing the present disclosure, a detailed description of a configuration determined that may unnecessarily obscure the subject matter of the present disclosure, for example, a detailed description of a known technology including the prior art may be omitted.

Hereinafter, exemplary embodiments of the present disclosure will be described in detail.

The present disclosure provides a method for recovering rare earth elements from rare earth permanent magnets, the method comprising: (a) crushing the rare earth permanent magnets; (b) digesting the crushed material obtained in step (a) in an alkaline solution; (c) subjecting the digested material obtained in step (b) to oxidative roasting; and (d) leaching the oxidatively roasted material obtained in step (c) with a deep eutectic solvent.

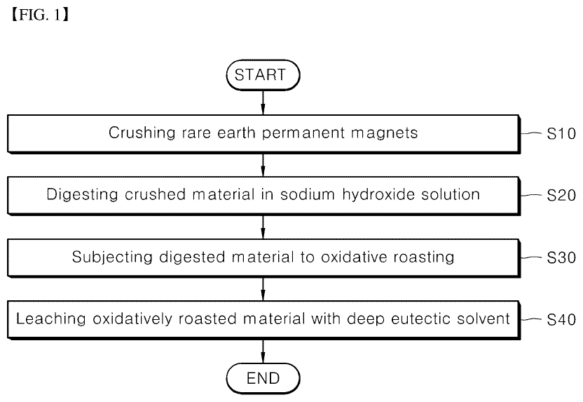

FIG. 1 is a process flow diagram illustrating a method for recovering rare earth elements from rare earth permanent magnets according to the present disclosure.

Hereinafter, the method will be described in detail step by step with reference to FIG. 1.

### (a) Crushing the Rare Earth Permanent Magnets (S10).

The present disclosure is directed to rare earth permanent magnets, which may be a compound of rare earth elements and iron, or waste thereof, preferably permanent magnets containing a compound of rare earth elements and iron, and more preferably a neodymium-iron-boron (Nd—Fe—B) based permanent magnets.

In addition, the present disclosure can be mainly applied to the recovery of rare earth elements from rare earth permanent magnet scraps or rare earth permanent magnet sludges.

The rare earth permanent magnets may be crushed to have a particle size of 100 μm or less, preferably 60 μm or less, and more preferably 30 μm or less. When the particle size of the crushed rare earth permanent magnets exceeds the above, there is a problem in that separation of rare earth elements and iron (Fe) is difficult to achieve. The alkaline digestion reaction proceeds from the particle surface of the waste permanent magnet powder toward the interior, and thus when the particle size of the waste permanent magnet powder is relatively large, it is difficult for the reaction to occur throughout the interior.

According to an embodiment of the present disclosure, when samples of waste permanent magnet powders respectively having particle sizes of 325 mesh (43 μm) or less and 500 mesh (28 μm) or less were subjected to sodium hydroxide digestion, oxidative roasting, and deep eutectic solvent leaching, it was confirmed that when the particle size was smaller, the leaching efficiency of Fe was lower, thereby improving the selectivity of rare earth leaching.

### (b) Digesting the Crushed Material Obtained in Step S10 in an Alkaline Solution (S20).

In this step, the crushed permanent magnets obtained in step S10 is digested in an alkaline solution to achieve phase separation of rare earth elements and iron, wherein the alkaline solution may be selected from the group consisting of sodium hydroxide solution, potassium hydroxide solution, calcium hydroxide solution, and magnesium hydroxide solution.

As can be confirmed in the exemplary embodiments of the present disclosure, in order to selectively leach rare earth elements using a deep eutectic solvent, it is preferable that the starting materials exist in the form of Nd₂O₃ and Fe₂O₃ (see Tables 2 and 3). However, when permanent magnets are converted into an oxide form through a general oxidative roasting process, Nd₂O₃ reacts with Fe to form NdFeO₃, and consequently only crystalline NdFeO₃/Fe₂O₃ remains, in which case the leaching efficiency of Nd is hindered.

Therefore, in order to suppress the formation of NdFeO₃, it is essential to achieve phase separation of Nd and Fe prior to oxidative roasting. For this purpose, an alkaline digestion process is introduced to convert Nd into Nd(OH)₃ and Fe into Fe₃O₄, thereby separating rare earth elements and iron into different phases, after which oxidative roasting yields Nd₂O₃/Fe₂O₃. Thus, in order to achieve selective leaching of rare earth elements using a deep eutectic solvent, it is required to digest the crushed permanent magnets in an alkaline solution to separate rare earth elements and iron into different phases prior to oxidative roasting as a pretreatment step.

The alkaline solution preferably has a concentration of 40 to 60% (w/w), and more preferably, the alkaline solution may be a sodium hydroxide solution or an aqueous sodium hydroxide solution. When the concentration of the alkaline solution is less than the above range, the digestion effect on the permanent magnet scraps is reduced, while when the concentration exceeds the above range, there is a drawback in that the digestion temperature increases.

The solid-to-liquid ratio of the crushed material and the alkaline solution is preferably 5 to 20% (w/v). When the solid-to-liquid ratio is less than the above range, the process productivity decreases, while when it exceeds the above range, the effect of the alkaline digestion is reduced.

The digestion may be carried out at 120 to 160° C. for 3 to 7 hours, and preferably at 140 to 150° C. for 4 to 6 hours. When outside the above ranges, the digestion effect is reduced.

### (c) Subjecting the Digested Material Obtained in Step S20 to Oxidative Roasting (S30).

In this step, the digested material in which rare earth elements and iron are phase-separated through alkaline digestion in step S20 is subjected to oxidative roasting to obtain Nd₂O₃/Fe₂O₃.

As shown in the exemplary embodiments of the present disclosure, when leaching with a deep eutectic solvent, it is necessary to convert the material into a form of Nd₂O₃ and Fe₂O₃, which exhibit higher leaching efficiency (see Tables 2 and 3).

The oxidative roasting may be carried out at 400 to 500° C. for 2 to 5 hours, and preferably at 420 to 470° C. for 3 to 4 hours. When outside the above ranges, there is a drawback in that the material is insufficiently converted into oxides or is converted into NdFeO₃.

(d) Leaching the Oxidatively Roasted Material Obtained in Step S30 with a Deep Eutectic Solvent (S40).

In this step, the oxidatively roasted material obtained in step S30 is leached with a deep eutectic solvent to selectively separate rare earth elements. When leaching with a deep eutectic solvent according to the present disclosure, higher selectivity can be achieved compared to acid leaching, thereby improving recovery efficiency, reducing purification steps, and enabling the deep eutectic solvent to be recycled within the process after precipitating and recovering rare earth elements from the leachate.

A deep eutectic solvent (DES) refers to a mixture in which two types of components are strongly hydrogen-bonded to form a compound having a melting point lower than that of each component, and is an environmentally friendly solvent that can replace organic solvents produced in the petrochemical industry. The deep eutectic solvent (DES) is produced by the formation of hydrogen bonds between a hydrogen bond acceptor (HBA) and a hydrogen bond donor (HBD).

According to the present disclosure, the deep eutectic solvent is a mixture of a hydrogen bond acceptor (HBA) and a hydrogen bond donor (HBD),
wherein the hydrogen bond acceptor may be selected from the group consisting of guanidine hydrochloride, choline chloride, ethylene glycol, N-ethyl-2-hydroxy-N,N-dimethylethanaminium chloride, 2-(chlorocarbonyloxy)-N,N,N-trimethylethanaminium chloride, N-benzyl-2-hydroxy-N,N-dimethylethanaminium, 1-aminoguanidine hydrochloride, 1,3-diaminoguanidine hydrochloride, methanol, betaine hydrochloride, benzylcholine chloride, tetrabutylammonium chloride, glycerol, 1,2-propanediol, 1,4-butanediol, etc.,
and wherein the hydrogen bond donor may be selected from the group consisting of lactic acid, maleic acid, urea, acetamide, 1-methylurea, 1,3-dimethylurea, 1,1-dimethylurea, thiourea, benzamide, glycerol, ethylene glycol, malonic acid, benzoic acid, adipic acid, oxalic acid, succinic acid, citric acid, malic acid, glycolic acid, proline, glucose, p-toluenesulfonic acid, tartaric acid, fructose, phenol, menthol, decanoic acid, ibuprofen, lidocaine, sucrose, etc.

As some examples of the deep eutectic solvent, guanidine hydrochloride-lactic acid, choline chloride-lactic acid, or ethylene glycol-maleic acid may be used.

The guanidine hydrochloride-lactic acid may be prepared by mixing guanidine hydrochloride and lactic acid at a molar ratio of 1:2 to 1:8, and preferably at a molar ratio of 1:2, and the preparation may be carried out at 60 to 80° C.

The choline chloride-lactic acid may be prepared by mixing choline chloride and lactic acid at a molar ratio of 1:1 to 1:10, and preferably at a molar ratio of 1:2, and the preparation may be carried out at 60 to 80° C.

The ethylene glycol-maleic acid may be prepared by mixing ethylene glycol and maleic acid at a molar ratio of 1:1 to 6:1, and preferably at a molar ratio of 4:1, and the preparation may be carried out at 50 to 70° C.

It is preferable that the preparation of the deep eutectic solvents is carried out by mixing the HBA and the HBD under the above conditions until a homogeneous state is achieved.

When outside the above molar ratio range, it may be difficult to prepare the deep eutectic solvent, and even if the deep eutectic solvent is successfully prepared, its physical properties may be altered, thereby negatively affecting leaching and solid-liquid separation.

When below the above temperature range, it may be difficult to prepare the deep eutectic solvent, while when exceeding the above temperature range, there is a possibility that the components may decompose.

The leaching may be carried out by maintaining a solid-to-liquid ratio of 1 to 3% (w/v) between the oxidatively roasted powder and the deep eutectic solvent, and preferably at a solid-to-liquid ratio of 1.0 to 1.5% (w/v).

The leaching is preferably carried out by applying ultrasound at 60 to 80° C. for 4 to 6 hours. At this time, the application of ultrasound has the effect of facilitating the leaching of rare earth elements.

For the recovery of rare earth elements from rare earth permanent magnets, it is preferable that steps (b) to (d) are carried out in order. When steps (b) to (d) are reversed or partially modified, the recovery of rare earth elements may be difficult or the process may not be feasible.

(e) the Method for Recovering Rare Earth Elements from Rare Earth Permanent Magnets May Further Comprise a Step of Reacting a Leachate Obtained in Step S40 with an Acid

In this step, an acid is added to and reacted with the leachate obtained in step S40 to recover rare earth elements.

The acid may be oxalic acid.

When oxalic acid is used as the acid, the rare earth elements are recovered in the form of rare earth oxalates.

Hereinafter, exemplary embodiments will be described in detail to specifically explain the present disclosure. However, the exemplary embodiments according to the present disclosure may be modified in various forms, and the scope of the present disclosure should not be construed as being limited to the embodiments described below. The exemplary embodiments of the present disclosure are provided to more fully explain the present disclosure to those of ordinary skill in the art.

### Preparation Example

The deep eutectic solvents (DESs) are prepared by the formation of hydrogen bonds between a hydrogen bond acceptor (HBA) and a hydrogen bond donor (HBD). In the following examples, guanidine hydrochloride-lactic acid, choline chloride-lactic acid, and ethylene glycol-maleic acid were prepared as deep eutectic solvents used for the leaching of Nd₂O₃. The HBA and the HBD were mixed under the conditions described in Table 1 until a homogeneous state was achieved, and then cooled to room temperature for use.

TABLE 1

| HBA(mole) | HBD(mole) | Temperature(° C.) |
|---|---|---|
| Guanidine hydrochloride(1) | Lactic acid (2) | 70 |
| Choline chloride(1) | Lactic acid (2) | 70 |
| Ethylene glycol(4) | Maleic acid (1) | 60 |

### Example 1

Using the three types of deep eutectic solvents described in Table 1, the leaching characteristics of the deep eutectic solvents were examined according to the phases of rare earth elements and iron compounds. Each deep eutectic solvent was mixed with the sample shown in Table 2 at a solid-to-liquid ratio of 1% (w/v), followed by leaching at 70° C. for 5 hours with the application of ultrasound. The leaching efficiencies are shown in Table 2.

TABLE 2

| | sample | | | |
|---|---|---|---|---|
| | leaching efficiency (% ) | | | |
| Deep eutectic solvents | Nd₂O₃ | Fe₂O₃ | Fe₃O₄ | Fe |
| Guanidine hydrochloride-Lactic acid | 100 | 6.83 | 99.97 | 98.9 |
| Choline chloride-Lactic acid | 100 | 3.56 | 21.13 | 94.3 |
| Ethylene glycol-Maleic acid | 100 | 0.48 | 0.91 | 100 |

Referring to Table 2, neodymium (Nd) was completely leached when present in the form of Nd₂O₃, while iron (Fe) exhibited a high leaching efficiency when present in the forms of Fe and Fe₃O₄, but a low leaching efficiency when present in the form of Fe₂O₃. Accordingly, it was confirmed that selective leaching is possible when rare earth elements and iron exist in the form of Nd₂O₃/Fe₂O₃ in NdFeB magnets.

### Example 2

In order to compare the leaching efficiency depending on the crystalline form of the sample, the following different treatments were carried out. NdFeB permanent magnet powder [provided by a domestic permanent magnet manufacturer, Nd 27.5 wt. %, Fe 63.6 wt. %] was treated as follows:
1) subjected to oxidative roasting at 600° C. for 5 hours to form NdFeO₃/Fe₂O₃ crystals;
2) subjected to roasting at 950° C. for 1.5 hours under an Ar atmosphere using H₂ as a reducing agent to form Nd₂O₃/Fe crystals; and
3) digested in a 50% aqueous sodium hydroxide solution (145° C., 5 hours) and subsequently subjected to oxidative roasting at 450° C. for 3 hours to form Nd₂O₃/Fe₂O₃/Fe₃O₄ crystals.

The pretreated permanent magnet powders obtained as described above were added to a guanidine hydrochloride-lactic acid deep eutectic solvent at a solid-to-liquid ratio of 1% (w/v), followed by leaching at 70° C. for 5 hours with the application of ultrasound. After leaching, solid-liquid separation was performed by centrifugation at 17,000 rpm for 20 minutes, and the results are shown in Table 3.

TABLE 3

| | | |
|---|---|---|
| crystalline form of the sample | Nd(%) | Fe(%) |

| | | | |
|---|---|---|---|
| 1) | NdFeO₃/Fe₂O₃ | 26.51 | 4.73 |
| 2) | Nd₂O₃/Fe | 91.1 | 91.1 |
| 3) | Nd₂O₃/Fe₂O₃/Fe₃O₄ | 96.95 | 14.51 |

Referring to Table 3, among the leaching results, the case of oxidative roasting after sodium hydroxide digestion exhibited the highest selectivity, but showed Fe leaching efficiency of 14.51%, which is considered to be due to the influence of Fe₃O₄.

### Example 3

In order to examine the effect of particle size of permanent magnet powder on sodium hydroxide digestion, the following experiment was carried out. NdFeB permanent magnet scraps were crushed and classified into samples of 325 mesh (43 μm) or less and 500 mesh (28 μm) or less, respectively. Each sample was subjected to sodium hydroxide digestion and subsequent oxidative roasting under the same conditions as in item (3) of Example 2, followed by leaching in a guanidine hydrochloride-lactic acid deep eutectic solvent with the application of ultrasound for 5 hours. The results are shown in Table 4 below.

TABLE 4

| particle size | Nd(%) | Fe(%) |
|---|---|---|
| <325 mesh | 97.83 | 19.52 |
| <500 mesh | 96.95 | 14.51 |

Referring to Table 4, when the particle size was smaller, the Fe leaching efficiency was lower, and when the particle size was larger, the Fe leaching efficiency was higher. This is considered to be because, after sodium hydroxide digestion, Fe remains in the metallic form inside the particles when the particle size is larger, thereby increasing the Fe leaching efficiency during deep eutectic solvent leaching and thus reducing selectivity.

### Example 4

As described in Examples 2 and 3, NdFeB permanent magnet powder subjected to sodium hydroxide digestion and oxidative roasting was leached with a guanidine hydrochloride-lactic acid deep eutectic solvent, and the Fe leaching efficiency was found to be 14.51%, which is considered to be due to the influence of Fe₃O₄. This indicates that whether Fe₃O₄ dissolves in the deep eutectic solvent has a significant effect on the selective leaching of rare earth elements. In addition, it is necessary to maintain conditions under which Fe₃O₄ is eliminated during the sodium hydroxide digestion and oxidative roasting processes, but this is a very difficult task.

Therefore, in order to examine whether the Fe₃O₄ leaching efficiency could be reduced by using other deep eutectic solvents, leaching experiments were conducted according to the type of deep eutectic solvent. The leaching method was the same as in item (3) of Example 2, and the results are shown in Table 5.

TABLE 5

| Deep eutectic solvents | Nd(%) | Fe(%) |
|---|---|---|
| Guanidine hydrochloride-Lactic acid | 96.95 | 14.51 |
| Choline chloride-Lactic acid | 90.60 | 4.26 |
| Ethylene glycol-Maleic acid | 97.99 | 1.30 |

Referring to Table 5, the ethylene glycol-maleic acid deep eutectic solvent exhibited a lower Fe leaching efficiency and higher selectivity for rare earth elements compared to the other two solvents, which is considered to be influenced by the leaching behavior of Fe₃O₄.

In addition, compared with the guanidine hydrochloride-lactic acid deep eutectic solvent and the choline chloride-lactic acid deep eutectic solvent, the ethylene glycol-maleic acid deep eutectic solvent showed higher selectivity for rare earth elements and lower viscosity, thereby facilitating solid-liquid separation and confirming its greater suitability for the selective leaching of permanent magnet powders.

### Example 5

Oxalic acid was added in an amount of 1.5 equivalents relative to the rare earth element to the guanidine hydrochloride-lactic acid deep eutectic solvent leachate obtained in Example 4, and reacted at room temperature for 2 hours, whereby 79.95% of Nd was recovered in the form of a neodymium oxalate.

In addition, oxalic acid was added in an amount of 1.5 equivalents relative to the rare earth element to the ethylene glycol-maleic acid deep eutectic solvent leachate obtained in Example 4, and reacted at room temperature for 2 hours, whereby 99.48% of Nd was recovered in the form of a neodymium oxalate.

In the above, exemplary embodiments of the method for recovering rare earth elements from rare earth permanent magnets according to the present disclosure have been described. Moreover, it will be appreciated that various modifications to these exemplary embodiments are possible without departing from the scope of the present disclosure.

The scope of the present disclosure should therefore not be limited to those exemplary embodiments described above, but should be defined by the following claims and their equivalents.

In other words, the foregoing exemplary embodiments are to be understood as illustrative rather than restrictive in all respects, and the scope of the present disclosure is indicated by the following claims rather than the detailed description. All modifications or variations derived from the meaning, scope, and equivalent concepts of the claims should be interpreted as being included within the scope of the present disclosure.

### INDUSTRIAL APPLICABILITY

The present disclosure relates to a method for recovering rare earth elements from rare earth permanent magnets using a deep eutectic solvent. By selectively leaching rare earth elements from rare earth permanent magnets, the recovery efficiency of the rare earth elements can be improved, the consumption of acid can be reduced, and the amount of wastewater generated can be decreased, thereby enabling an environmentally friendly process.

1. A method for recovering rare earth elements from rare earth permanent magnets, comprising:
(a) crushing the rare earth permanent magnets;
(b) digesting the crushed material obtained in step (a) in an alkaline solution;
(c) subjecting the digested material obtained in step (b) to oxidative roasting; and
(d) leaching the oxidatively roasted material obtained in step (c) with a deep eutectic solvent,
wherein the oxidatively roasted material contains Fe₃O₄.

2. The method of claim 1,
wherein in step (a),
the rare earth permanent magnets are neodymium-iron-boron (Nd—Fe—B) based permanent magnets.

3. The method of claim 1,
wherein in step (a),
the rare earth permanent magnets are waste permanent magnet scraps or permanent magnet sludges.

4. The method of claim 1,
wherein in step (a),
the rare earth permanent magnets are crushed to have a particle size of 100 μm or less.

5. The method of claim 1,
wherein in step (b),
the alkaline solution has a concentration of 40 to 60% (w/w).

6. The method of claim 1,
wherein in step (b),
the digesting is carried out at a solid-to-liquid ratio of 5 to 20% (w/v).

7. The method of claim 1,
wherein in step (b),
the digesting is carried out at 120 to 160° C. for 3 to 7 hours.

8. The method of claim 1,
wherein the oxidative roasting in step (c) is carried out at 400 to 500° C. for 2 to 5 hours.

9. The method of claim 1,
wherein the deep eutectic solvent in step (d) is a mixture of a hydrogen bond acceptor (HBA) and a hydrogen bond donor (HBD),
wherein the hydrogen bond acceptor is selected from the group consisting of guanidine hydrochloride, choline chloride, ethylene glycol, N-ethyl-2-hydroxy-N,N-dimethylethanaminium chloride, 2-(chlorocarbonyloxy)-N,N,N-trimethylethanaminium chloride, N-benzyl-2-hydroxy-N,N-dimethylethanaminium, 1-aminoguanidine hydrochloride, 1,3-diaminoguanidine hydrochloride, methanol, betaine hydrochloride, benzylcholine chloride, tetrabutylammonium chloride, glycerol, 1,2-propandiol, and 1,4-butanediol,
and wherein the hydrogen bond donor is selected from the group consisting of lactic acid, maleic acid, urea, acetamide, 1-methyl urea, 1,3-dimethyl urea, 1,1-dimethyl urea, thiourea, benzamide, glycerol, ethylene glycol, malonic acid, benzoic acid, adipic acid, oxalic acid, succinic acid, citric acid, malic acid, glycolic acid, proline, glucose, p-toluene sulfonic acid, tartaric acid, fructose, phenol, menthol, decanoic acid, ibuprofen, lidocaine, and sucrose.

10. The method of claim 9,
wherein the deep eutectic solvent is prepared by mixing guanidine hydrochloride and lactic acid at a molar ratio of 1:2 to 1:8.

11. The method of claim 10,
wherein the preparation is carried out at 60 to 80° C.

12. The method of claim 9,
wherein the deep eutectic solvent is prepared by mixing choline chloride and lactic acid at a molar ratio of 1:1 to 1:10.

13. The method of claim 12,
wherein the preparation is carried out at 60 to 80° C.

14. The method of claim 9,
wherein the deep eutectic solvent is prepared by mixing ethylene glycol and maleic acid at a molar ratio of 1:1 to 6:1.

15. The method of claim 14,
wherein the preparation is carried out at 50 to 70° C.

16. The method of claim 1,
wherein the leaching in step (d) is carried out by applying ultrasound at 60 to 80° C. for 4 to 6 hours.

17. The method of claim 1, further comprising:
(e) reacting a leachate obtained in step (d) with an acid.
